(19) United States
(12) Patent Application Publication
(10) Pub. No.: US 2025/0265991 A1
(43) Pub. Date: Aug. 21, 2025

(54) DISPLAY DEVICE AND METHOD OF OPERATING A DISPLAY DEVICE

(71) Applicant: SAMSUNG ELECTRONICS CO., LTD., Suwon-si (KR)

(72) Inventors: DONGIN KIM, Yongin-si (KR); KANG-MIN KIM, Yongin-si (KR); BYOUNGCHEL KIM, Yongin-si (KR); HYE RYEON JO, Yongin-si (KR); TAEKYOUNG KIM, Yongin-si (KR)

(21) Appl. No.: 18/979,754

(22) Filed: Dec. 13, 2024

(30) Foreign Application Priority Data
Feb. 19, 2024 (KR) 10-2024-0023846

(51) Int. Cl. G09G 3/3233; G09G 3/20

(52) U.S. Cl. CPC G09G 3/3233; G09G 3/2074; G09G 3/2092; G09G 2300/0452; G09G 2300/0842; G09G 2310/08; G09G 2320/0242; G09G 2320/041

(57) ABSTRACT

A display device includes a display panel including a plurality of pixels, and a panel driver coupled to the display panel. The panel driver stores color coordinate compensation data representing a color coordinate compensation value according to a temperature value and a light emitting element efficiency, stores efficiency data representing the light emitting element efficiency according to a gray level, determines temperature values of the plurality of pixels to determine color coordinate compensation values for the plurality of pixels based on the color coordinate compensation data, the efficiency data and the temperature values of the plurality of pixels, generates corrected image data by correcting input image data based on the color coordinate compensation values, and drives the display panel based on the corrected image data.

This application claims priority to Korean Patent Application No. 10-2024-0023846, filed on Feb. 19, 2024, and all the benefits accruing therefrom under 35 USC § 119, the content of which in its entirety is herein incorporated by reference.

### BACKGROUND

### 1. Field

The present invention relates to a display device, and more particularly to a display device performing a color coordinate compensation operation, and a method of operating the display device.

### 2. Description of the Related Art

During a manufacturing process of a display device, a luminance and color correction (LCC) operation may be performed on the display device so that a plurality of pixels of the display device have a desired luminance, a desired gamma curve and a desired color coordinate. This LCC operation may be performed by measuring the luminance and/or the color coordinate of an image of the display device to generate compensation data and by writing the compensation data into the display device.

When a display device on which this LCC operation has been performed initially operates, the display device may display an image having a desired color coordinate. However, after a certain driving time has passed, a color drift phenomenon in which the color coordinate changes depending on a temperature, a gray level, etc. may occur in the display device.

### SUMMARY

The invention provides a display device capable of preventing a color drift phenomenon.

The invention provides a method of operating a display device capable of preventing a color drift phenomenon.

According to an embodiment, there is provided a display device including a display panel including a plurality of pixels, and a panel driver coupled to the display panel. The panel driver stores color coordinate compensation data representing a color coordinate compensation value according to a temperature value and a light emitting element efficiency. The panel driver further stores efficiency data representing the light emitting element efficiency according to a gray level, determines temperature values of the plurality of pixels, to determine color coordinate compensation values for the plurality of pixels based on the color coordinate compensation data, the efficiency data and the temperature values of the plurality of pixels, generates corrected image data by correcting input image data based on the color coordinate compensation values, and drives the display panel based on the corrected image data.

In an embodiment, the panel driver may include a color coordinate compensation lookup table configured to store the color coordinate compensation data, and an efficiency lookup table configured to store the efficiency data. The panel driver may determine the light emitting element efficiency corresponding to a gray level as indicated by the input image data for each of the plurality of pixels using the efficiency lookup table, and may determine the color coordinate compensation value corresponding to the temperature value and the light emitting element efficiency for each of the plurality of pixels using the color coordinate compensation lookup table.

In an embodiment, with respect to each of the plurality of pixels, the panel driver may generate the corrected image data by adding the color coordinate compensation value to a color coordinate corresponding to the input image data.

In an embodiment, the panel driver may include a scan driver configured to provide scan signals to the plurality of pixels, a data driver configured to provide data signals to the plurality of pixels based on the corrected image data, a sensing circuit configured to generate sensing values by performing a sensing operation on the plurality of pixels, a nonvolatile memory configured to store the color coordinate compensation data and the efficiency data, and a controller configured to determine the color coordinate compensation values for the plurality of pixels based on the color coordinate compensation data, the efficiency data and the temperature values of the plurality of pixels. Additionally, the panel drive may generate the corrected image data by correcting the input image data based on the color coordinate compensation values.

In an embodiment, the sensing circuit may generate the sensing values for pixels in at least one row among the plurality of pixels by performing the sensing operation on the pixels in the at least one row during a blank period of a frame period, and may provide the sensing values for the pixels in the at least one row to the controller. The controller may determine the temperature values of the pixels in the at least one row based on the sensing values for the pixels in the at least one row.

In an embodiment, the at least one row on which the sensing operation is performed may be randomly selected from a plurality of rows during the blank period of each frame period.

In an embodiment, each of the plurality of pixels may include a red subpixel, a green subpixel and a blue subpixel. To store the color coordinate compensation data, the nonvolatile memory may include a red color coordinate compensation lookup table configured to store red color coordinate compensation values for the red subpixel at a plurality of reference temperatures and a plurality of reference red light emitting element efficiencies, a green color coordinate compensation lookup table configured to store green color coordinate compensation values for the green subpixel at the plurality of reference temperatures and a plurality of reference green light emitting element efficiencies, and a blue color coordinate compensation lookup table configured to store blue color coordinate compensation values for the blue subpixel at the plurality of reference temperatures and a plurality of reference blue light emitting element efficiencies. To store the efficiency data, the nonvolatile memory may further include a red efficiency lookup table configured to store red light emitting element efficiencies for the red subpixel at a plurality of reference gray levels, a green efficiency lookup table configured to store green light emitting element efficiencies for the green subpixel at the plurality of reference gray levels, and a blue efficiency lookup table configured to store blue light emitting element efficiencies for the blue subpixel at the plurality of reference gray levels.

In an embodiment, the controller may include a data loading unit in which the red color coordinate compensation lookup table, the green color coordinate compensation lookup table, the blue color coordinate compensation lookup table, the red efficiency lookup table, the green efficiency lookup table and the blue efficiency lookup table are uploaded from the nonvolatile memory, the sensing values are uploaded from the sensing circuit, and the input image data are uploaded. The controller may further include a compensation value determining unit configured to determine the light emitting element efficiency of each of the red, green and blue subpixels using the input image data, the red efficiency lookup table, the green efficiency lookup table and the blue efficiency lookup table, to determine the temperature values of the red, green and blue subpixels based on the sensing values for the red, green and blue subpixels, and to determine the color coordinate compensation values for the red, green and blue subpixels using the light emitting element efficiency of each of the red, green and blue subpixels, the temperature values of the red, green and blue subpixels, the red color coordinate compensation lookup table, the green color coordinate compensation lookup table and the blue color coordinate compensation lookup table. The controller may also include a data correcting unit configured to generate the corrected image data for the red, green and blue subpixels by correcting the input image data for the red, green and blue subpixels based on the color coordinate compensation values for the red, green, and blue subpixels.

In an embodiment, the compensation value determining unit may extract the red light emitting element efficiencies at two reference gray levels which are disposed adjacent to a gray level indicated by the input image data for the red subpixel among the plurality of reference gray levels from the red efficiency lookup table, and may determine the light emitting element efficiency of the red subpixel by interpolating the red light emitting element efficiencies at the two reference gray levels. The compensation value determining unit may extract the green light emitting element efficiencies at two reference gray levels which are disposed adjacent to a gray level indicated by the input image data for the green subpixel among the plurality of reference gray levels from the green efficiency lookup table, and may determine the light emitting element efficiency of the green subpixel by interpolating the green light emitting element efficiencies at the two reference gray levels. The compensation value determining unit may extract the blue light emitting element efficiencies at two reference gray levels which are disposed adjacent to a gray level indicated by the input image data for the blue subpixel among the plurality of reference gray levels from the blue efficiency lookup table, and may determine the light emitting element efficiency of the blue subpixel by interpolating the blue light emitting element efficiencies at the two reference gray levels.

In an embodiment, the compensation value determining unit may extract the red color coordinate compensation values at two reference temperatures which are disposed adjacent to the temperature value of the red subpixel among the plurality of reference temperatures and at two reference red light emitting element efficiencies which are disposed adjacent to the light emitting element efficiency of the red subpixel among the plurality of reference red light emitting element efficiencies from the red color coordinate compensation lookup table, and may determine the color coordinate compensation value for the red subpixel by interpolating the red color coordinate compensation values at the two reference temperatures and at the two reference red light emitting element efficiencies. The compensation value determining unit may extract the green color coordinate compensation values at two reference temperatures which are disposed adjacent to the temperature value of the green subpixel among the plurality of reference temperatures and at two reference green light emitting element efficiencies which are disposed adjacent to the light emitting element efficiency of the green subpixel among the plurality of reference green light emitting element efficiencies from the green color coordinate compensation lookup table, and may determine the color coordinate compensation value for the green subpixel by interpolating the green color coordinate compensation values at the two reference temperatures and at the two reference green light emitting element efficiencies. The compensation value determining unit may extract the blue color coordinate compensation values at two reference temperatures which are disposed adjacent to the temperature value of the blue subpixel among the plurality of reference temperatures and at two reference blue light emitting element efficiencies which are disposed adjacent to the light emitting element efficiency of the blue subpixel among the plurality of reference blue light emitting element efficiencies from the blue color coordinate compensation lookup table, and may determine the color coordinate compensation value for the blue subpixel by interpolating the blue color coordinate compensation values at the two reference temperatures and at the two reference blue light emitting element efficiencies.

In an embodiment, the data correcting unit may include a first color space converting unit configured to convert the input image data in a first color space into color coordinate data and luminance data in a second color space, a compensation value applying unit configured to calculate a compensation sum vector by summing a first vector corresponding to the color coordinate compensation value for the red subpixel, a second vector corresponding to the color coordinate compensation value for the green subpixel and a third vector corresponding to the color coordinate compensation value for the blue subpixel, and to calculate compensated color coordinate data by applying the compensation sum vector to the color coordinate data in the second color space, and a second color space converting unit configured to convert the compensated color coordinate data and the luminance data in the second color space into the corrected image data in the first color space.

In an embodiment, the display device may further include a plurality of temperature sensors arranged at a plurality of reference positions of the display panel.

In an embodiment, the panel driver may receive reference temperature values for the plurality of reference positions from the plurality of temperature sensors. With respect to each of the plurality of pixels, the panel driver may determine the temperature value of each of the plurality of pixels by interpolating the reference temperature values at four reference positions disposed adjacent to each of the plurality of pixels among the plurality of reference positions.

According to an embodiment, there is provided a display device including a display panel including a plurality of pixels, and a panel driver coupled to the display panel. The panel driver stores color coordinate compensation data representing a color coordinate compensation value according to an accumulated driving value and a light emitting element efficiency, stores efficiency data representing the light emitting element efficiency according to a gray level, determines accumulated driving values of the plurality of pixels based on input image data, determines color coordinate compensation values for the plurality of pixels based on the color coordinate compensation data, the efficiency data and the accumulated driving values of the plurality of pixels, generates corrected image data by correcting input image data based on the color coordinate compensation values, and drives the display panel based on the corrected image data.

In an embodiment, the panel driver may include a scan driver configured to provide scan signals to the plurality of pixels, a data driver configured to provide data signals to the plurality of pixels based on the corrected image data, a nonvolatile memory configured to store the color coordinate compensation data and the efficiency data, and a controller configured to determine the color coordinate compensation values for the plurality of pixels based on the color coordinate compensation data, the efficiency data and the accumulated driving values of the plurality of pixels, and to generate the corrected image data by correcting the input image data based on the color coordinate compensation values.

In an embodiment, the controller may include a data loading unit in which the color coordinate compensation data and the efficiency data are loaded from the nonvolatile memory, and the input image data are loaded, an accumulated driving calculating unit configured to calculate the accumulated driving values of the plurality of pixels by accumulating the input image data during a plurality of frame periods, a compensation value determining unit configured to determine the light emitting element efficiencies of the plurality of pixels based on the efficiency data and the input image data, and to determine the color coordinate compensation values for the plurality of pixels based on the color coordinate compensation data, the light emitting element efficiencies of the plurality of pixels and the accumulated driving values of the plurality of pixels, and a data correcting unit configured to generate the corrected image data for the plurality of pixels by correcting the input image data for the plurality of pixels based on the color coordinate compensation values for the plurality of pixels.

In an embodiment, with respect to each of the plurality of pixels, the accumulated driving calculating unit may calculate the accumulated driving value of each of the plurality of pixels by summing the input image data for each of the plurality of pixels during the plurality of frame periods, and products of the input image data and weights for pixels which are disposed adjacent to each of the plurality of pixels during the plurality of frame periods.

According to an embodiment, there is provided a method of operating a display device. In the method, color coordinate compensation data representing a color coordinate compensation value according to a temperature value and a light emitting element efficiency are stored, efficiency data representing the light emitting element efficiency according to a gray level are stored, temperature values of a plurality of pixels of the display device are determined, color coordinate compensation values for the plurality of pixels are determined based on the color coordinate compensation data, the efficiency data and the temperature values of the plurality of pixels, corrected image data are generated by correcting input image data based on the color coordinate compensation values, and the display panel is driven based on the corrected image data.

In an embodiment, to determine the temperature values of the plurality of pixels, sensing values for pixels in at least one row among the plurality of pixels may be generated by performing a sensing operation on the pixels in the at least one row during a blank period of a frame period, where the temperature values of the pixels in the at least one row may be determined based on the sensing values for the pixels in the at least one row.

In an embodiment, to determine the color coordinate compensation values for the plurality of pixels, light emitting element efficiencies of the plurality of pixels may be determined based on the efficiency data and the input image data, and the color coordinate compensation values for the plurality of pixels may be determined based on the color coordinate compensation data, the light emitting element efficiencies of the plurality of pixels and the temperature values of the plurality of pixels.

As described above, in a display device and a method of operating the display device, according to an embodiment, color coordinate compensation data representing a color coordinate compensation value according to a temperature value and a light emitting element efficiency may be stored, efficiency data representing the light emitting element efficiency according to a gray level may be stored, temperature values of a plurality of pixels may be determined, color coordinate compensation values for the plurality of pixels may be determined based on the color coordinate compensation data, the efficiency data and the temperature values of the plurality of pixels, and image data may be corrected based on the color coordinate compensation values. Accordingly, a color drift phenomenon may be prevented in the display device.

### BRIEF DESCRIPTION OF THE DRAWINGS

Illustrative, non-limiting embodiments will be more clearly understood from the following detailed description in conjunction with the accompanying drawings.

FIG. 1 is a schematic block diagram illustrating a display device, according to an embodiment.

FIG. 2 is a schematic circuit diagram illustrating an example of each subpixel included in a display device, according to an embodiment.

FIG. 3 is a timing diagram for describing an example of a sensing operation performed during a blank period of each frame period, according to an embodiment.

FIG. 4 is a temperature diagram illustrating an example of a temperature value corresponding to a sensing value, according to an embodiment.

FIG. 5 is a schematic block diagram illustrating a controller included in a display device of FIG. 1, according to an embodiment.

FIG. 6 is a diagram illustrating examples of a red color coordinate compensation lookup table, a green color coordinate compensation lookup table and a blue color coordinate compensation lookup table included in a display device of FIG. 1, according to an embodiment.

FIG. 7 is a diagram illustrating examples of a red efficiency lookup table, a green efficiency lookup table and a blue efficiency lookup table included in a display device of FIG. 1, according to an embodiment.

FIG. 8 is a block diagram illustrating an example of a data correcting unit included in the controller of FIG. 3, according to an embodiment.

FIG. 9 is a color coordinate diagram for describing an example in which a color coordinate compensation value is applied to color coordinate data, according to an embodiment.

FIG. 10 is a flowchart illustrating a method of operating a display device, according to an embodiment.

FIG. 11 is a schematic block diagram illustrating a display device, according to an embodiment.

FIG. 12 is a diagram for describing an example in which a temperature value of each pixel is determined, according to an embodiment.

FIG. 13 is a schematic block diagram illustrating a display device, according to an embodiment.

FIG. 14 is a schematic block diagram illustrating a controller included in a display device of FIG. 13, according to an embodiment.

FIG. 15 is a diagram for describing an example of an accumulated driving value that is calculated by accumulating input image data in a plurality of frame periods, according to an embodiment.

FIG. 16 is a diagram for describing an example of an accumulated driving value that is calculated for each pixel, according to an embodiment.

FIG. 17 is a diagram illustrating examples of a red color coordinate compensation lookup table, a green color coordinate compensation lookup table and a blue color coordinate compensation lookup table included in a display device of FIG. 13, according to an embodiment.

FIG. 18 is a block diagram illustrating an electronic device including a display device, according to an embodiment.

### DETAILED DESCRIPTION

Hereinafter, embodiments of the invention will be explained in detail with reference to the accompanying drawings. The same reference numerals are used for the same components in the drawings, and redundant descriptions of the same components will be omitted.

It will be understood that when an element (or a region, a layer, a portion, or the like) is referred to as being related to another such as being “on”, “connected to” or “coupled to” another element, it may be directly disposed on, connected or coupled to the other element, or intervening elements may be disposed therebetween.

Like reference numerals or symbols refer to like elements throughout. In the drawings, the thickness, the ratio, and the size of the element are exaggerated for effective description of the technical contents. As used herein, the term “and/or” includes any and all combinations of one or more of the associated listed items.

The term “and/or,” may include all combinations of one or more of which associated configurations may define.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the scope of the inventive concept. Similarly, a second element, component, region, layer or section may be termed a first element, component, region, layer or section. As used herein, the singular forms, “a”, “an” and “the” are intended to include the plural forms as well, unless the context clearly indicates otherwise.

Also, terms of “below”, “on lower side”, “above”, “on upper side”, or the like may be used to describe the relationships of the elements illustrated in the drawings. These terms have relative concepts and are described on the basis of the directions indicated in the drawings.

It will be further understood that the terms “comprise”, “includes” and/or “have”, when used in this specification, specify the presence of stated features, integers, steps, operations, elements, components, and/or groups thereof, but do not preclude the presence or addition of one or more other features, integers, steps, operations, elements, components, and/or groups thereof. As used herein, being “disposed directly on” may mean that there is no additional layer, film, region, plate, or the like between a part and another part such as a layer, a film, a region, a plate, or the like. For example, being “disposed directly on” may mean that two layers or two members are disposed without using an additional member such as an adhesive member, therebetween.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

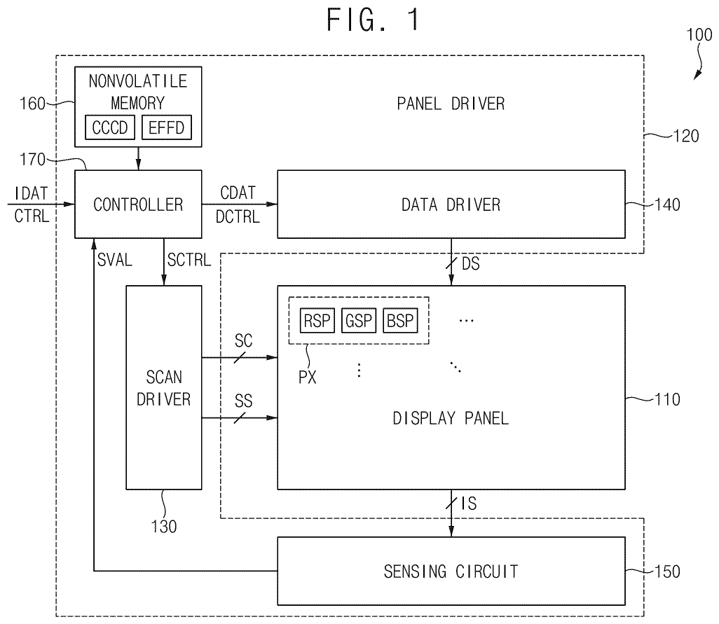

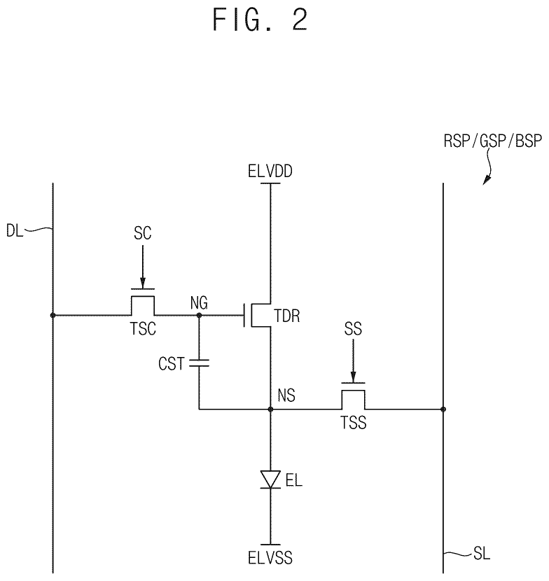

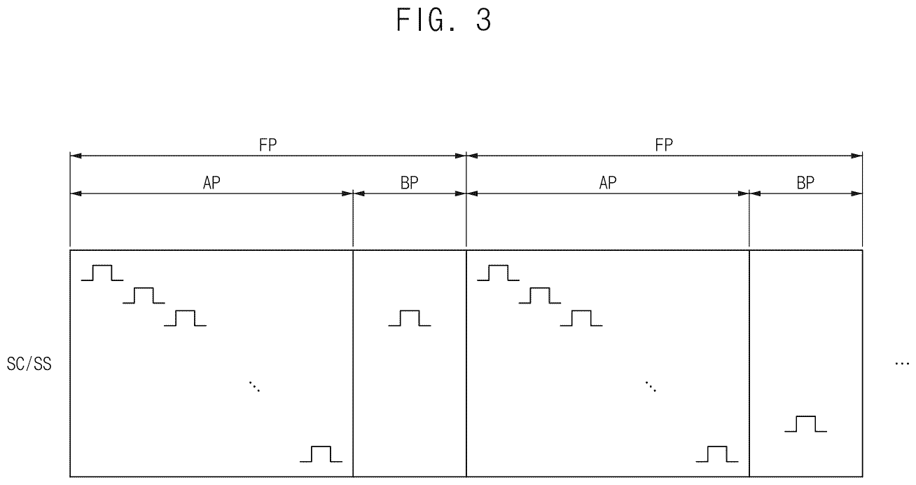

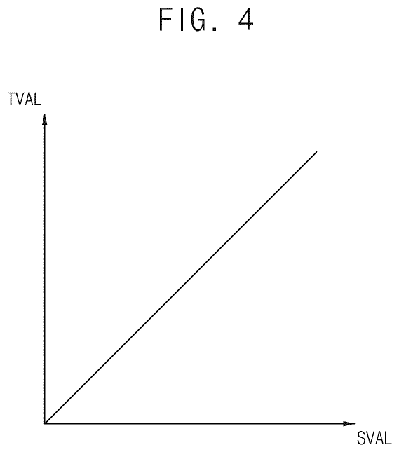

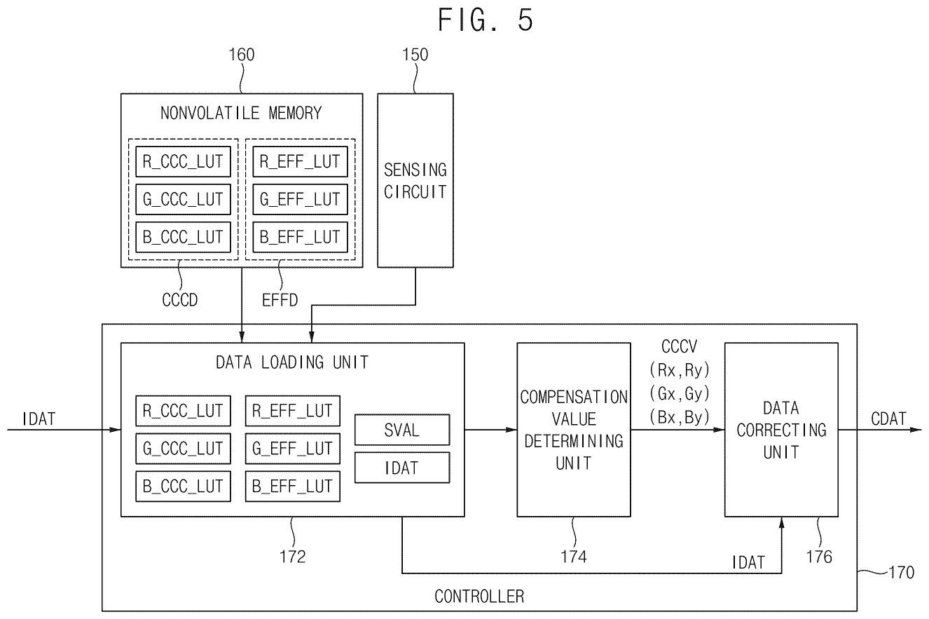

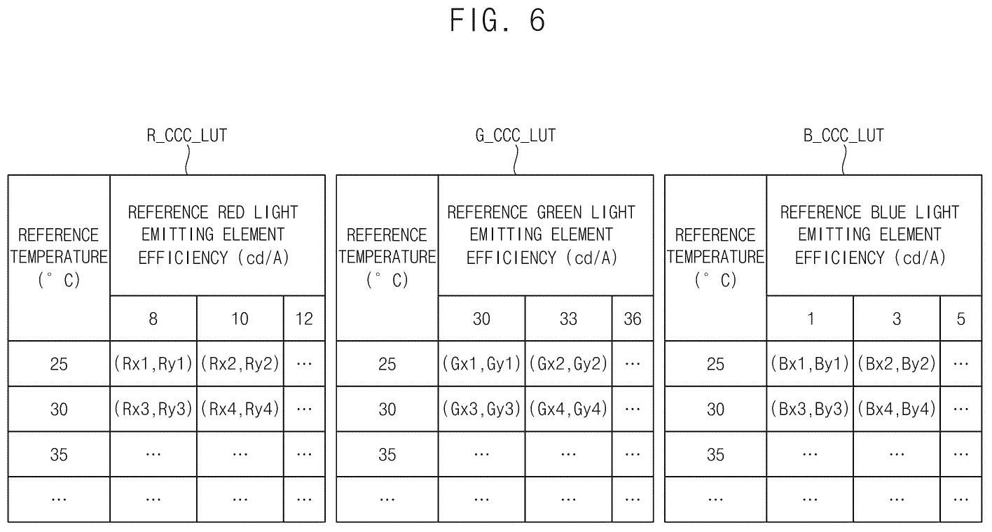

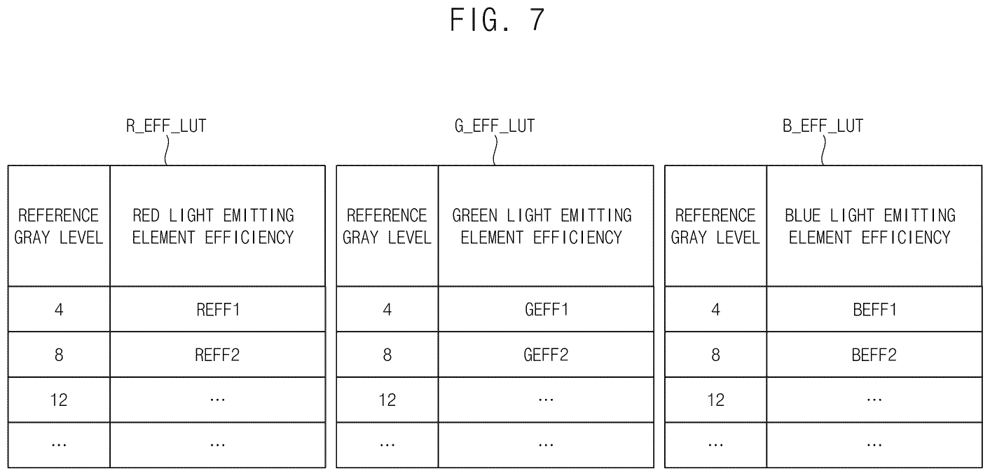

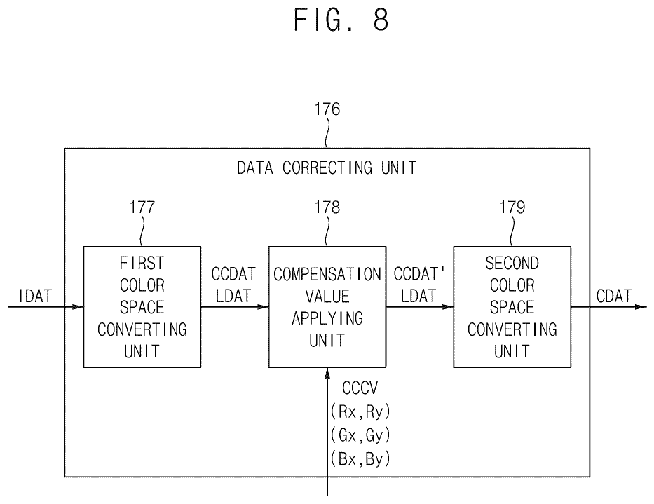

FIG. 1 is a block diagram illustrating a display device, according to an embodiment, FIG. 2 is a circuit diagram illustrating an example of each subpixel included in a display device, according to an embodiment, FIG. 3 is a diagram for describing an example of a sensing operation performed in a blank period of each frame period, according to an embodiment, FIG. 4 is a diagram illustrating an example of a temperature value according to a sensing value, according to an embodiment, FIG. 5 is a block diagram illustrating a controller included in a display device of FIG. 1, according to an embodiment, FIG. 6 is a diagram illustrating examples of a red color coordinate compensation lookup table, a green color coordinate compensation lookup table and a blue color coordinate compensation lookup table included in a display device of FIG. 1, according to an embodiment, FIG. 7 is a diagram illustrating examples of a red efficiency lookup table, a green efficiency lookup table and a blue efficiency lookup table included in a display device of FIG. 1, according to an embodiment, and FIG. 8 is a block diagram illustrating an example of a data correcting unit included in the controller of FIG. 3, according to an embodiment.

In an embodiment and referring to FIG. 1, a display device 100 may include a display panel 110 that includes a plurality of pixels PX, and a panel driver 120 connected to the display panel 110 and configured to drive the display panel 110. In an embodiment, the panel driver 120 may include a scan driver 130 that provides scan signals SC and/or sensing signals SS to the plurality of pixels PX, a data driver 140 that provides data signals DS to the plurality of pixels PX, a sensing circuit 150 that performs a sensing operation on the plurality of pixels PX, a nonvolatile memory 160 that stores color coordinate compensation data CCCD and efficiency data EFFD, and a controller 170 that controls an operation of the display device 100.

The display panel 110 may include a plurality of data lines, a plurality of sensing lines, and the plurality of pixels PX connected thereto. The display panel 110 may further include scan signal lines for providing the scan signals SC to the plurality of pixels PX, and/or sensing signal lines for providing the sensing signals SS to the plurality of pixels PX. In an embodiment, each pixel PX may include a red subpixel RSP that emits red light, a green subpixel GSP that emits green light and a blue subpixel BSP that emits blue light.

In an embodiment and as illustrated in FIG. 2, each of the red subpixel RSP, green subpixel GSP and blue subpixel BSP may include a driving transistor TDR, a scan transistor TSC, a sensing transistor TSS, a storage capacitor CST and a light emitting element EL.

The storage capacitor CST may store the data signal DS transferred through a data line DL. In an embodiment, the storage capacitor CST may include a first electrode connected to a gate node NG, and a second electrode connected to a source node NS.

The scan transistor TSC may connect the data line DL to the gate node NG in response to the scan signal SC. Thus, the scan transistor TSC may transfer the data signal DS of the data line DL to the gate node NG in response to the scan signal SC. In an embodiment, the scan transistor TSC may include a gate that receives the scan signal SC, a first terminal connected to the data line DL, and a second terminal connected to the gate node NG.

The sensing transistor TSS may connect the sensing line SL to the source node NS in response to the sensing signal SS. In an embodiment, the sensing transistor TSS may include a gate that receives the sensing signal SS, a first terminal connected to the sensing line SL, and a second terminal connected to the source node NS.

The driving transistor TDR may generate a driving current based on the data signal DS stored in the storage capacitor CST. In an embodiment, the driving transistor TDR may include a gate connected to the gate node NG, a first terminal (e.g., a drain) connected to a line that transfers a first power supply voltage ELVDD (e.g., a high power supply voltage), and a second terminal (e.g., a source) connected to the source node NS.

The light emitting element EL may emit light based on the driving current generated by the driving transistor TDR. According to an embodiment, the light emitting element EL may be an organic light-emitting diode (OLED), a micro light emitting diode, a nano light emitting diode (NED), a quantum dot (QD) light emitting diode, an inorganic light emitting diode, or any other suitable light emitting element. In an embodiment, the light emitting element EL may include an anode connected to the source node NS, and a cathode connected to a line that transfers a second power supply voltage ELVSS (e.g., a low power supply voltage).

Although FIG. 2 illustrates an example of the red, green and blue subpixels RSP, GSP, BSP, respectively, the red, green and blue subpixels RSP, GSP, BSP, respectively, of the display device 100, according to another embodiment, is not limited to the example of FIG. 2.

In an embodiment, the scan driver 130 may generate the scan signals SC and/or the sensing signals SS based on a scan control signal SCTRL received from the controller 170, and may sequentially provide the scan signals SC and/or the sensing signals SS to the plurality of pixels PX in a row-by-row basis during an active period of a frame period. In an embodiment, the scan control signal SCTRL may include, but is not limited to, a start signal and a clock signal. In an embodiment, the scan driver 130 may be integrated or formed in the display panel 110. In other embodiments, the scan driver 130 may be implemented with one or more integrated circuits.

The data driver 140 may generate the data signals DS based on corrected image data CDAT and a data control signal DCTRL received from the controller 170, and may provide the data signals DS to the plurality of pixels PX during the active period. In an embodiment, the data control signal DCTRL may include, but is not limited to, a data enable signal, a horizontal start signal, a load signal, etc. In an embodiment, the data driver 140 may be implemented with one or more integrated circuits. In other embodiments, the data driver 140 and the controller 170 may be implemented with a single integrated circuit, and the single integrated circuit may be referred to as a timing controller embedded data driver (TED).

The sensing circuit 150 may receive sensing currents IS from the plurality of pixels PX through the plurality of sensing lines SL by performing the sensing operation on the plurality of pixels PX, and may provide sensing values SVAL corresponding to the sensing currents IS to the controller 170. The controller 170 may determine temperature values of the plurality of pixels PX based on the sensing values SVAL for the plurality of pixels PX. In an embodiment, the sensing circuit 150 may be implemented as an integrated circuit that is separate from an integrated circuit of the data driver 140. In other embodiments, the sensing circuit 150 may be included in the data driver 140 or the controller 170.

In an embodiment and as illustrated in FIG. 3, during the active period AP of each frame period FP, the scan signals SC and the sensing signals SS may be sequentially applied to the pixels PX in a plurality of rows of the display panel 110, the data signals DS may be sequentially applied to the plurality of pixels PX on a row-by-row basis, and the plurality of pixels PX may display an image based on the data signals DS. Further, during a blank period BP of each frame period FP, the sensing circuit 150 may generate sensing values SVAL for pixels PX which are disposed in at least one row among the plurality of pixels PX by performing the sensing operation on the pixels PX in the at least one row, and may provide the sensing values SVAL for the pixels PX in the at least one row to the controller 170. In an embodiment, the sensing operations for the plurality of rows may be sequentially performed during a plurality of blank periods BP of a plurality of frame periods FP. In other embodiments, as illustrated in FIG. 3, the pixels PX in the at least one row on which the sensing operation is performed may be randomly selected from the plurality of rows of the display panel 110 during the blank period BP of each frame period FP. The controller 170 may determine the temperature value of each pixel PX based on the sensing value SVAL for the pixel PX. For example, as illustrated in FIG. 4, the temperature value TVAL determined by the controller 170 for each pixel PX may increase as the sensing value SVAL of the pixel PX increases.

In an embodiment, the nonvolatile memory 160 may store the color coordinate compensation data CCCD and the efficiency data EFFD, where the color coordinate compensation data CCCD represents a color coordinate compensation value according to the temperature value TVAL and light emitting element efficiency, and where the efficiency data EFFD represents the light emitting element efficiency according to a gray level. In an embodiment, the same color coordinate compensation data CCCD may be previously determined and stored in display devices 100 of the same model, and the efficiency data EFFD may be determined and stored when a luminance and color correction (LCC) operation is performed for each of the display devices 100. Further, in an embodiment, each of the color coordinate compensation data CCCD and the efficiency data EFFD may be stored in the form of a lookup table. For example, in an embodiment, the nonvolatile memory 160 may include a color coordinate compensation lookup table that stores the color coordinate compensation data CCCD, and an efficiency lookup table that stores the efficiency data EFFD.

In an embodiment, the controller 170 (e.g., a timing controller) may receive input image data IDAT and a control signal CTRL from an external host processor (e.g., an application processor, a graphics processing unit or a graphics card). In an embodiment, the control signal CTRL may include, but is not limited to, a vertical synchronization signal, a horizontal synchronization signal, an input data enable signal, a master clock signal, etc. The controller 170 may determine color coordinate compensation values for the plurality of pixels PX based on the color coordinate compensation data CCCD, the efficiency data EFFD and the temperature values TVAL of the plurality of pixels PX, and also may generate the corrected image data CDAT by correcting the input image data IDAT based on the color coordinate compensation values. Further, the controller 170 may generate the data control signal DCTRL and the scan control signal SCTRL based on the control signal CTRL. The controller 170 may control an operation of the scan driver 130 by providing the scan control signal SCTRL to the scan driver 130 and may control an operation of the data driver 140 by providing the corrected image data CDAT and the data control signal DCTRL to the data driver 140.

In the display device 100, according to an embodiment, the panel driver 120 may determine the temperature values TVAL of the plurality of pixels PX. The panel driver 120 may also determine the color coordinate compensation values for the plurality of pixels PX based on the color coordinate compensation data CCCD, the efficiency data EFFD and the temperature values TVAL of the plurality of pixels PX, and may generate the corrected image data CDAT by correcting the input image data IDAT based on the color coordinate compensation values. Moreover, the panel driver 120 and may drive the display panel 110 based on the corrected image data CDAT. In an embodiment, the panel driver 120 may determine the light emitting element efficiency which corresponds to a gray level indicated by the input image data IDAT for each pixel PX by using the efficiency lookup table that stores the efficiency data EFFD. The panel driver may also determine the color coordinate compensation value corresponding to the temperature value TVAL and the light emitting element efficiency for each pixel PX by using the color coordinate compensation lookup table that stores the color coordinate compensation data CCCD. Further, the panel driver 120 may generate the corrected image data CDAT by adding the color coordinate compensation value to a color coordinate which corresponds to the input image data IDAT with respect to each pixel PX.

In an embodiment, to store the color coordinate compensation data CCCD, as illustrated in FIG. 5, the nonvolatile memory 160 may include a red color coordinate compensation lookup table R_CCC_LUT that stores red color coordinate compensation values for the red subpixel RSP at a plurality of reference temperatures and a plurality of reference red light emitting element efficiencies, a green color coordinate compensation lookup table G_CCC_LUT that stores green color coordinate compensation values for the green subpixel GSP at the plurality of reference temperatures and a plurality of reference green light emitting element efficiencies, and a blue color coordinate compensation lookup table B_CCC_LUT that stores blue color coordinate compensation values for the blue subpixel BSP at the plurality of reference temperatures and a plurality of reference blue light emitting element efficiencies. For example, in an embodiment and as illustrated in FIG. 6, the red color coordinate compensation lookup table R_CCC_LUT may store the red color coordinate compensation values (Rx1,Ry1), (Rx2,Ry2), (Rx3,Ry3), (Rx4,Ry4), etc., at the reference temperatures of about 25 degrees, about 30 degrees, about 35 degrees, etc. and the reference red light emitting element efficiencies of about 8 cd/A, about 10 cd/A, about 12 cd/A, etc., the green color coordinate compensation lookup table G_CCC_LUT may store the green color coordinate compensation values (Gx1,Gy1), (Gx2,Gy2), (Gx3,Gy3), (Gx4,Gy4), etc., at the reference temperatures of about 25 degrees, about 30 degrees, about 35 degrees, etc. and the reference green light emitting element efficiencies of about 30 cd/A, about 33 cd/A, about 36 cd/A, etc., and the blue color coordinate compensation lookup table B_CCC_LUT may store the blue color coordinate compensation values (Bx1,By1), (Bx2,By2), (Bx3,By3), (Bx4,By4), etc., at the reference temperatures of about 25 degrees, about 30 degrees, about 35 degrees, etc., and the reference blue light emitting element efficiencies of about 1 cd/A, about 3 cd/A, about 5 cd/A, etc.

Furthermore, to store the efficiency data EFFD, the nonvolatile memory 160 may further include a red efficiency lookup table R_EFF_LUT that stores red light emitting element efficiencies for the red subpixel RSP at a plurality of reference gray levels, a green efficiency lookup table G_EFF_LUT that stores green light emitting element efficiencies for the green subpixel GSP at the plurality of reference gray levels, and a blue efficiency lookup table B_EFF_LUT that stores blue light emitting element efficiencies for the blue subpixel BSP at the plurality of reference gray levels. For example, as illustrated in FIG. 7, the red efficiency lookup table R_EFF_LUT may store the red light emitting element efficiencies REFF1, REFF2, etc., at the reference gray levels of about 4-gray level, about 8-gray level, about 12-gray level, etc., the green efficiency lookup table G_EFF_LUT may store the green light emitting element efficiencies GEFF1, GEFF2, etc., at the reference gray levels of about 4-gray level, about 8-gray level, about 12-gray level, etc., and the blue efficiency lookup table B_EFF_LUT may store the blue light emitting element efficiencies BEFF1, BEFF2, etc., at the reference gray levels of about 4-gray level, about 8-gray level, about 12-gray level, etc.

Further, in an embodiment and as illustrated in FIG. 5, the controller 170 may include a data loading unit 172, a compensation value determining unit 174 and a data correcting unit 176.

In the data loading unit 172, the red color coordinate compensation lookup table R_CCC_LUT, the green color coordinate compensation lookup table G_CCC_LUT, the blue color coordinate compensation lookup table B_CCC_LUT, the red efficiency lookup table R_EFF_LUT, the green efficiency lookup table G_EFF_LUT and the blue efficiency lookup table B_EFF_LUT may be uploaded from the nonvolatile memory 160. In an embodiment, the red, green and blue color coordinate compensation lookup tables R_CCC_LUT, G_CCC_LUT and B_CCC_LUT, respectively, and the red, green and blue efficiency lookup tables R_EFF_LUT, G_EFF_LUT and B_EFF_LUT, respectively, may be uploaded from the nonvolatile memory 160 to the data loading unit 172 when the display device 100 is powered on. Further, in the data loading unit 172, the sensing values SVAL for the plurality of pixels PX may be uploaded from the sensing circuit 150. In an embodiment, the sensing values SVAL for the pixels PX in at least one row may be updated during each frame period FP. Further, in the data loading unit 172, the input image data IDAT may be uploaded from the external host processor.

In an embodiment, the compensation value determining unit 174 may determine the light emitting element efficiency of each of the red, green and blue subpixels RSP, GSP and BSP, respectively, using the input image data IDAT, the red efficiency lookup table R_EFF_LUT, the green efficiency lookup table G_EFF_LUT and the blue efficiency lookup table B_EFF_LUT. In an embodiment, the compensation value determining unit 174 may extract the red light emitting element efficiency which corresponds to the gray level indicated by the input image data IDAT for the red subpixel RSP from the red efficiency lookup table R_EFF_LUT, the green light emitting element efficiency corresponding to the gray level indicated by the input image data IDAT for the green subpixel GSP from the green efficiency lookup table G_EFF_LUT, and the blue light emitting element efficiency corresponding to the gray level indicated by the input image data IDAT for the blue subpixel BSP from the blue efficiency lookup table B_EFF_LUT. Further, if the gray level indicated by the input image data IDAT for each of the red, green and blue subpixels RSP, GSP and BSP, respectively, is not the reference gray level, the compensation value determining unit 174 may determine the light emitting element efficiency of each of the red, green and blue subpixels RSP, GSP and BSP, respectively, by interpolating the light emitting element efficiencies at the reference gray levels. For example, if the input image data IDAT represents a 6-gray level with respect to the red subpixel RSP, the compensation value determining unit 174 may extract the red light emitting element efficiencies REFF1 and REFF2 at two reference gray levels (e.g., i.e., a 4-gray level and a 8-gray level) which are disposed adjacent to the 6-gray level from the red efficiency lookup table R_EFF_LUT illustrated in FIG. 7, and may interpolate the red light emitting element efficiencies REFF1 and REFF2 at the two reference gray levels to determine the light emitting element efficiency of the red subpixel RSP as “(REFF1+REFF2)/2”. Further, if the input image data IDAT represents the 6-gray level with respect to the green subpixel GSP, the compensation value determining unit 174 may extract the green light emitting element efficiencies GEFF1 and GEFF2 at the two reference gray levels which are disposed adjacent to the 6-gray level from the green efficiency lookup table G_EFF_LUT illustrated in FIG. 7, and may interpolate the green light emitting element efficiencies GEFF1 and GEFF2 at the two reference gray levels to determine the light emitting element efficiency of the green subpixel GSP as “(GEFF1+GEFF2)/2”. Moreover, if the input image data IDAT represents the 6-gray level with respect to the blue subpixel BSP, the compensation value determining unit 174 may extract the blue light emitting element efficiencies BEFF1 and BEFF2 at the two reference gray levels which are disposed adjacent to the 6-gray level from the blue efficiency lookup table B_EFF_LUT illustrated in FIG. 7, and may interpolate the blue light emitting element efficiencies BEFF1 and BEFF2 at the two reference gray levels to determine the light emitting element efficiency of the blue subpixel BSP as “(BEFF1+BEFF2)/2”.

In an embodiment, the compensation value determining unit 174 may determine the temperature values TVAL of the red, green and blue subpixels RSP, GSP and BSP, respectively, based on the sensing values SVAL for the red, green and blue subpixels RSP, GSP and BSP, respectively. For example, as illustrated in FIG. 4, the compensation value determining unit 174 may determine the temperature values TVAL of the red, green and blue subpixels RSP, GSP and BSP, respectively, in proportion to the sensing values SVAL for the red, green and blue subpixels RSP, GSP and BSP, respectively.

The compensation value determining unit 174 may determine the color coordinate compensation values CCCV for the red, green and blue subpixels RSP, GSP and BSP, respectively, by using the light emitting element efficiencies of the red, green and blue subpixels RSP, GSP and BSP, respectively, the temperature values TVAL of the red, green and blue subpixels RSP, GSP and BSP, respectively, the red color coordinate compensation lookup table R_CCC_LUT, the green color coordinate compensation lookup table G_CCC_LUT and the blue color coordinate compensation lookup table B_CCC_LUT. In an embodiment, the compensation value determining unit 174 may extract the red color coordinate compensation value (Rx,Ry) corresponding to the temperature value TVAL and the red light emitting element efficiency of the red subpixel RSP from the red color coordinate compensation lookup table R_CCC_LUT, the green color coordinate compensation value (Gx,Gy) corresponding to the temperature value TVAL and the green light emitting element efficiency of the green subpixel GSP from the green color coordinate compensation lookup table G_CCC_LUT, and the blue color coordinate compensation value (Bx,By) corresponding to the temperature value TVAL and the blue light emitting element efficiency of the blue subpixel BSP from the blue color coordinate compensation lookup table B_CCC_LUT. Further, with respect to each of the red, green and blue subpixels RSP, GSP and BSP, respectively, if the temperature value TVAL is not the reference temperature or the light emitting element efficiency is not a reference light emitting element efficiency, the compensation value determining unit 174 may determine the color coordinate compensation value of each of the red, green and blue subpixels RSP, GSP and BSP, respectively, by interpolating the color coordinate compensation values extracted from the color coordinate compensation lookup table. For example, if the temperature value TVAL of the red subpixel RSP is about 27.5 degrees and the red light emitting element efficiency of the red subpixel RSP is about 9 cd/A, the compensation value determining unit 174 may extract the red color coordinate compensation values (Rx1,Ry1), (Rx2,Ry2), (Rx3,Ry3) and (Rx4,Ry4), at the reference temperatures of about 25 degrees and about 30 degrees, which are disposed adjacent to about 27.5 degrees and the reference red light emitting element efficiencies of about 8 cd/A and about 10 cd/A adjacent to about 9 cd/A from the red color coordinate compensation lookup table R_CCC_LUT, and may determine the color coordinate compensation value (Rx,Ry) for the red subpixel RSP as “((Rx1+Rx2+Rx3+Rx4)/4, (Ry1+Ry2+Ry3+Ry4)/4)” by interpolating the red color coordinate compensation values (Rx1,Ry1), (Rx2,Ry2), (Rx3,Ry3) and (Rx4,Ry4) extracted from the red color coordinate compensation lookup table R_CCC_LUT. Further, as another example, if the temperature value TVAL of the green subpixel GSP is about 27.5 degrees and the green light emitting element efficiency of the green subpixel GSP is about 31.5 cd/A, the compensation value determining unit 174 may extract the green color coordinate compensation values (Gx1,Gy1), (Gx2,Gy2), (Gx3,Gy3) and (Gx4,Gy4), at the reference temperatures of about 25 degrees and about 30 degrees, which are disposed adjacent to about 27.5 degrees and the reference green light emitting element efficiencies of about 30 cd/A and about 33 cd/A adjacent to about 31.5 cd/A from the green color coordinate compensation lookup table G_CCC_LUT, and may determine the color coordinate compensation value (Gx,Gy) for the green subpixel GSP as “((Gx1+Gx2+Gx3+Gx4)/4, (Gy1+Gy2+Gy3+Gy4)/4)” by interpolating the green color coordinate compensation values (Gx1,Gy1), (Gx2,Gy2), (Gx3,Gy3) and (Gx4,Gy4) extracted from the green color coordinate compensation lookup table G_CCC_LUT. Further, in still another example, if the temperature value TVAL of the blue subpixel BSP is about 27.5 degrees and the blue light emitting element efficiency of the blue subpixel BSP is about 2 cd/A, the compensation value determining unit 174 may extract the blue color coordinate compensation values (Bx1,By1), (Bx2,By2), (Bx3,By3) and (Bx4,By4), at the reference temperatures of about 25 degrees and about 30 degrees, which are disposed adjacent to about 27.5 degrees and the reference blue light emitting element efficiencies of about 1 cd/A and about 3 cd/A which are disposed adjacent to about 2 cd/A from the blue color coordinate compensation lookup table B_CCC_LUT, and may determine the color coordinate compensation value (Bx,By) for the blue subpixel BSP as “((Bx1+Bx2+Bx3+Bx4)/4, (By1+By2+By3+By4)/4)” by interpolating the blue color coordinate compensation values (Bx1,By1), (Bx2,By2), (Bx3,By3) and (Bx4,By4) extracted from the blue color coordinate compensation lookup table B_CCC_LUT.

The data correcting unit 176 may generate the corrected image data CDAT for the red, green and blue subpixels RSP, GSP and BSP, respectively, by correcting the input image data IDAT for the red, green and blue subpixels RSP, GSP and BSP, respectively, based on the color coordinate compensation values CCCV for the red, green and blue subpixels RSP, GSP and BSP, respectively.

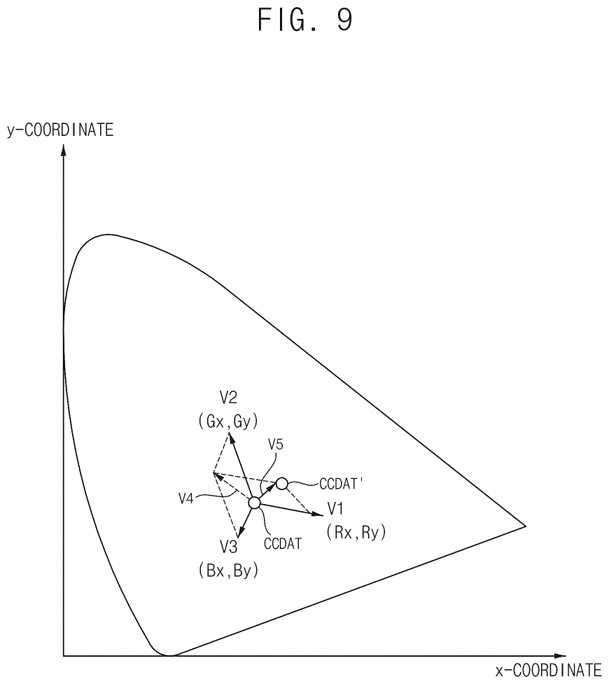

In an embodiment and as illustrated in FIG. 8, the data correcting unit 176 may include a first color space converting unit 177 that converts the input image data IDAT in a first color space (e.g., an RGB color space) into color coordinate data CCDAT and luminance data LDAT in a second color space (e.g., an XYZ color space or an xyLv color space), a compensation value applying unit 178 that calculates a compensation sum vector by summing a first vector corresponding to the color coordinate compensation value (Rx,Ry) for the red subpixel RSP, a second vector corresponding to the color coordinate compensation value (Gx,Gy) for the green subpixel GSP and the third vector corresponding to the color coordinate compensation value (Bx,By) for the blue subpixel BSP, and that calculates compensated color coordinate data CCDAT′ by applying the compensation sum vector to the color coordinate data CCDAT in the second color space, and a second color space converting unit 179 that converts the compensated color coordinate data CCDAT′ and the luminance data LDAT in the second color space into the corrected image data CDAT in the first color space. For example, as illustrated in FIG. 9, the compensation value applying unit 178 may generate a fourth vector V4 by adding the second vector V2 which corresponds to the color coordinate compensation value (Gx,Gy) for the green subpixel GSP and the third vector V3 which corresponds to the color coordinate compensation value (Bx,By) for the blue subpixel BSP. Additionally, the compensation value applying unit 178 may generate a fifth vector V5 that is a compensation sum vector of the first, second and third vectors V1, V2 and V3, respectively, by summing the fourth vector V4 and the first vector V1 which corresponds to the color coordinate compensation value (Rx,Ry) for the red subpixel RSP, and may also generate the compensated color coordinate data CCDAT′ indicating a color coordinate to which the compensation sum vector is applied by applying the fifth vector V5 to a color coordinate indicated by the color coordinate data CCDAT. An image displayed based on the corrected image data CDAT which is generated from the compensated color coordinate data CCDAT′ may have a desired color coordinate.

As described above, in the display device 100, according to an embodiment, the color coordinate compensation values CCCV (or the red color coordinate compensation value (Rx,Ry), the green color coordinate compensation value (Gx,Gy) and the blue color coordinate compensation value (Bx,By)) for the plurality of pixels PX may be determined based on the color coordinate compensation data CCCD (or the red, green and blue color coordinate compensation lookup tables R_CCC_LUT, G_CCC_LUT and B_CCC_LUT), the efficiency data EFFD (or the red, green and blue efficiency lookup tables R_EFF_LUT, G_EFF_LUT and B_EFF_LUT) and the temperature values TVAL of the plurality of pixels PX, and the corrected image data CDAT may be generated by correcting the input image data IDAT based on the color coordinate compensation values CCCV, and an image may be displayed based on the corrected image data CDAT. The image displayed based on the corrected image data CDAT may have the desired color coordinate, and thus, a color drift phenomenon may be prevented in the display device 100.

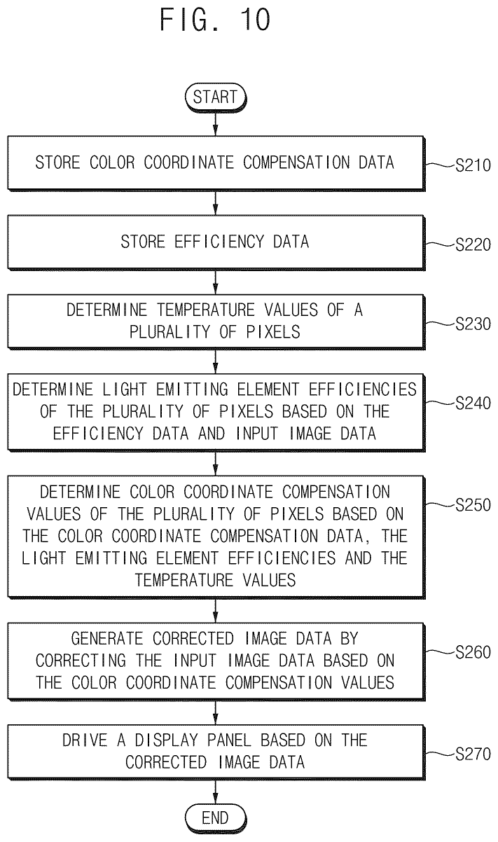

FIG. 10 is a flowchart illustrating a method of operating a display device, according to an embodiment.

In an embodiment and referring to FIGS. 1 and 10, a panel driver 120 of a display device 100 may store color coordinate compensation data CCCD representing a color coordinate compensation value according to a temperature value and light emitting element efficiency (S210) and may store efficiency data EFFD representing the light emitting element efficiency according to a gray level (S220). In an embodiment, the panel driver 120 may store each of the color coordinate compensation data CCCD and the efficiency data EFFD in the form of a lookup table.

The panel driver 120 may determine temperature values of a plurality of pixels PX of a display panel 110 (S230). In an embodiment, a sensing circuit 150 may generate sensing values SVAL for pixels PX in at least one row by performing a sensing operation on the pixels PX in the at least one row during a blank period of each frame period, and may determine the temperature values of the pixels PX in the at least one row based on the sensing values SVAL for the pixels PX in the at least one row.

In an embodiment, the panel driver 120 may determine color coordinate compensation values for the plurality of pixels PX based on the color coordinate compensation data CCCD, the efficiency data EFFD and the temperature values of the plurality of pixels PX (S240 and S250). In an embodiment, the panel driver 120 may determine light emitting element efficiencies of the plurality of pixels PX based on the efficiency data EFFD and input image data IDAT (S240), and may determine the color coordinate compensation values for the plurality of pixels PX based on the color coordinate compensation data CCCD, the light emitting element efficiencies of the plurality of pixels PX and the temperature values of the plurality of pixels PX (S250).

In an embodiment, the panel driver 120 may generate corrected image data CDAT by correcting the input image data IDAT based on the color coordinate compensation values (S260), and may drive the display panel 110 based on the corrected image data CDAT (S270). The display panel 110 driven based on the corrected image data CDAT may display an image having a desired color coordinate, and a color drift phenomenon can be prevented in the display device 100.

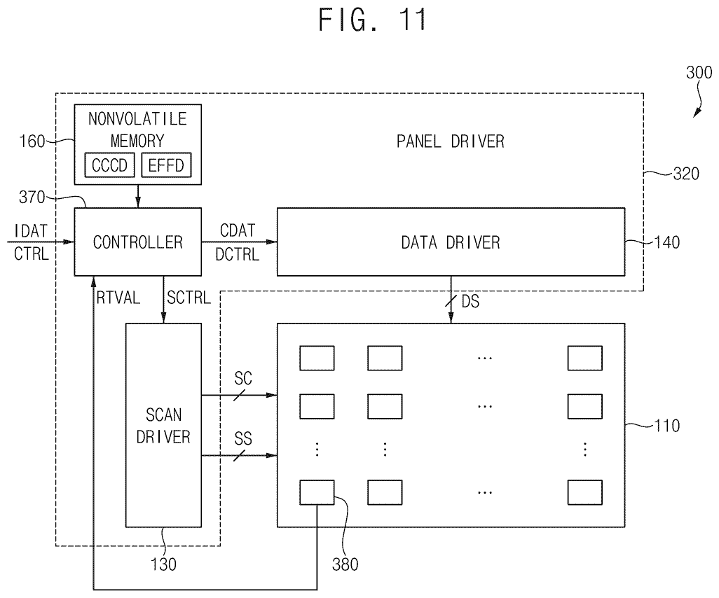

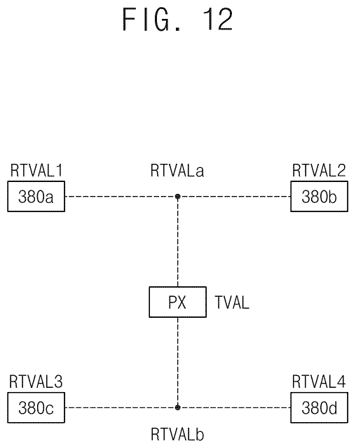

FIG. 11 is a block diagram illustrating a display device, according to an embodiment, and FIG. 12 is a diagram for describing an example in which a temperature value of each pixel is determined, according to an embodiment.

In an embodiment and referring to FIG. 11, a display device 300 may include a display panel 110, a panel driver 320 and a plurality of temperature sensors 380, where the display device 300 of FIG. 11 may have a similar configuration and a similar operation to the display device 100 of FIG. 1, with the exception that a temperature value of each pixel PX may be determined by using the plurality of temperature sensors 380.

The plurality of temperature sensors 380 may be arranged at a plurality of reference positions of the display panel 110 and may measure reference temperature values RTVAL at the plurality of reference positions. A controller 370 of the panel driver 320 may receive the reference temperature values RTVAL at the plurality of reference positions from the plurality of temperature sensors 380 and may determine the temperature value of each pixel PX by interpolating the reference temperature values RTVAL at the plurality of reference positions. For example, in an embodiment and as illustrated in FIG. 12, with respect to each pixel PX, the controller 370 may determine the temperature value TVAL of the pixel PX based on a first reference temperature value RTVAL1, a second reference temperature value RTVAL2, a third reference temperature value RTVAL3 and a fourth reference temperature value RTVAL4 of a first temperature sensor 380a, a second temperature sensor 380b, a third temperature sensor 380c and a fourth temperature sensor 380d, respectively, at four reference positions which are disposed adjacent to the pixel PX among the plurality of reference positions. The controller 370 may generate a first intermediate reference temperature value RTVALa by interpolating the first reference temperature value RTVAL1 and the second reference temperature value RTVAL2, a second intermediate reference temperature value RTVALb by interpolating the third reference temperature value RTVAL3 and the fourth reference temperature value RTVAL4, and may determine the temperature value TVAL of the pixel PX by interpolating the first intermediate reference temperature value RTVALa and the second intermediate reference temperature value RTVALb.

In an embodiment, the panel driver 320 may determine color coordinate compensation values for the plurality of pixels PX based on color coordinate compensation data CCCD, efficiency data EFFD and the temperature values TVAL of the plurality of pixels PX, generate corrected image data CDAT by correcting input image data IDAT based on the color coordinate compensation values, and drive the display panel 110 to display an image based on the corrected image data CDAT. The image displayed based on the corrected image data CDAT may have a desired color coordinate, and thus, a color drift phenomenon may be prevented in the display device 300.

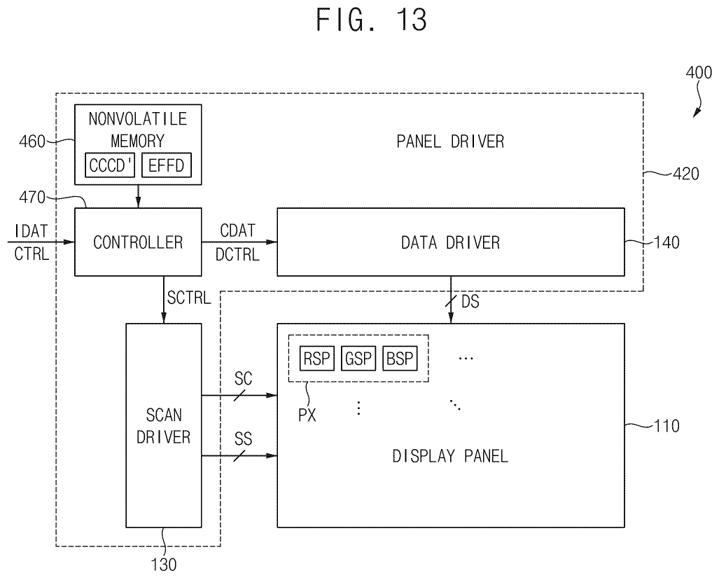

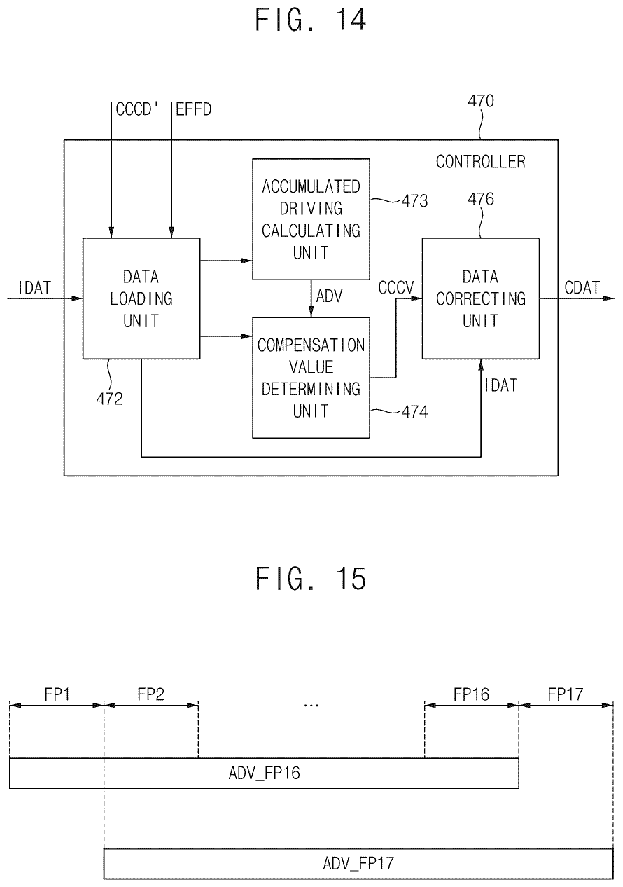

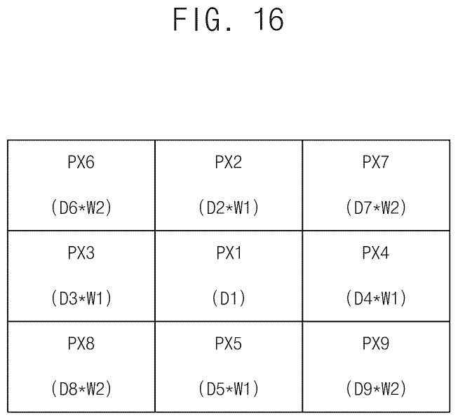

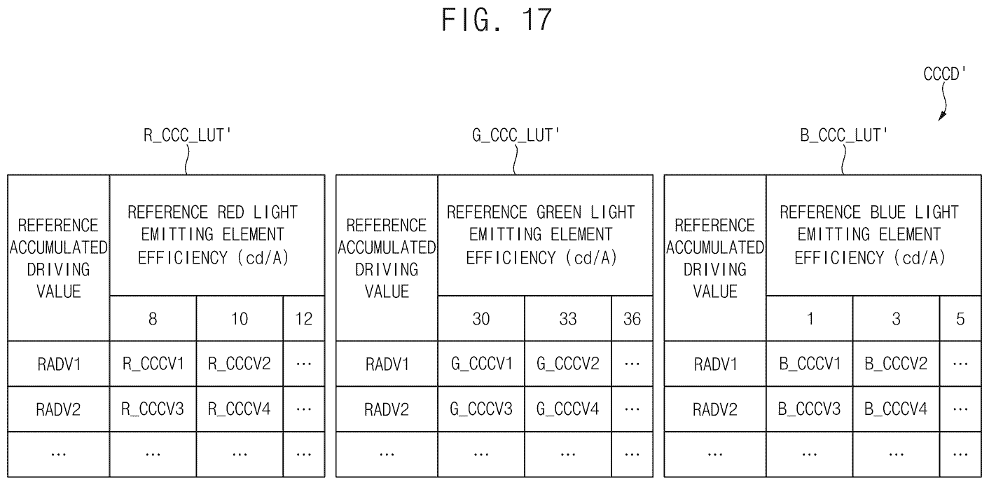

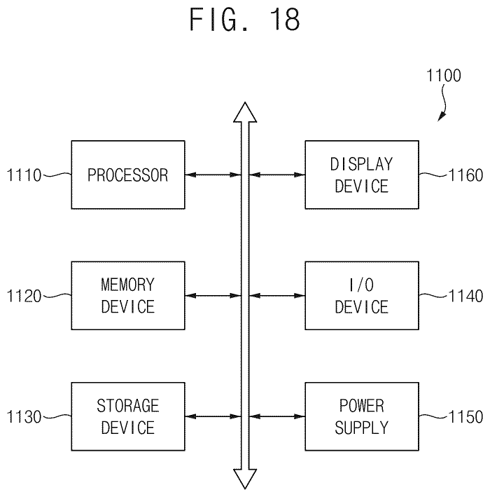

FIG. 13 is a block diagram illustrating a display device, according to an embodiment, FIG. 14 is a block diagram illustrating a controller included in a display device of FIG. 13 according to an embodiment, FIG. 15 is a diagram for describing an example of an accumulated driving value that is calculated by accumulating input image data during a plurality of frame periods, according to an embodiment, FIG. 16 is a diagram for describing an example of an accumulated driving value that is calculated for each pixel, according to an embodiment, and FIG. 17 is a diagram illustrating examples of a red color coordinate compensation lookup table, a green color coordinate compensation lookup table and a blue color coordinate compensation lookup table included in a display device of FIG. 13, according to an embodiment.

In an embodiment and referring to FIG. 13, a display device 400 may include a display panel 110 and a panel driver 420. The panel driver 420 may include a scan driver 130, a data driver 140, a nonvolatile memory 460 and a controller 470. The display device 400 of FIG. 14 may have a similar configuration and a similar operation to a display device 100 of FIG. 1, with the exception that an accumulated driving value of each pixel PX may be used instead of a temperature value of each pixel PX.

In an embodiment, color coordinate compensation data CCCD′ stored in the nonvolatile memory 460 may represent a color coordinate compensation value according to the accumulated driving value and light emitting element efficiency. In an embodiment, the color coordinate compensation data CCCD′ may be stored in the form of a lookup table, and may be stored for each of a red subpixel RSP, a green subpixel GSP and a blue subpixel BSP. For example, to store the color coordinate compensation data CCCD′, as illustrated in FIG. 17, the nonvolatile memory 460 may include a red color coordinate compensation lookup table R_CCC_LUT′ that stores red color coordinate compensation values R_CCCV1, R_CCCV2, R_CCCV3, R_CCCV4, etc., for the red subpixel RSP at a plurality of reference accumulated driving values RADV1, RADV2, etc., and a plurality of reference red light emitting element efficiencies, a green color coordinate compensation lookup table G_CCC_LUT′ that stores green color coordinate compensation values G_CCCV1, G_CCCV2, G_CCCV3, G_CCCV4, etc., for a green subpixel GSP at the plurality of reference accumulated driving values RADV1, RADV2, etc., and a plurality of reference green light emitting element efficiencies, and a blue color coordinate compensation lookup table B_CCC_LUT′ that stores blue color coordinate compensation values B_CCCV1, B_CCCV2, B_CCCV3, B_CCCV4, etc., for the blue subpixel BSP at the plurality of reference accumulated driving values RADV1, RADV2, etc., and a plurality of reference blue light emitting element efficiencies.

The controller 470 may determine the accumulated driving values of the plurality of pixels PX based on input image data IDAT, may determine color coordinate compensation values for the plurality of pixels PX based on the color coordinate compensation data CCCD′, the efficiency data EFFD and the accumulated driving values of the plurality of pixels PX, and may generate corrected image data CDAT by correcting the input image data IDAT based on the color coordinate compensation values. To perform these operations, as illustrated in FIG. 14, the controller 470 may include a data loading unit 472, an accumulated driving calculating unit 473, a compensation value determining unit 474 and a data correcting unit 476.

In the data loading unit 472, the color coordinate compensation data CCCD′ (or red, green and blue color coordinate compensation lookup tables R_CCC_LUT′, G_CCC_LUT′ and B_CCC_LUT′) and the efficiency data EFFD may be uploaded from the nonvolatile memory 460, and the input image data IDAT may be uploaded from an external host processor.

In an embodiment, the accumulated driving calculating unit 473 may calculate the accumulated driving values ADV of the plurality of pixels PX by accumulating the input image data IDAT during a plurality of frame periods. For example, as illustrated in FIG. 15, the accumulated driving calculating unit 473 may calculate an accumulated driving value ADV_FP16 during a sixteenth frame period FP16 by accumulating the input image data IDAT during the first through sixteenth frame periods FP1 through FP16, respectively, and may calculate an accumulated driving value ADV_FP17 during a seventeenth frame period FP17 by accumulating the input image data IDAT during the second through seventeenth frame periods FP2 through FP17, respectively. Although FIG. 15 illustrates an example in which the accumulated driving value ADV is calculated by accumulating the input image data IDAT during sixteen frame periods, the accumulated driving value ADV calculated by the accumulated driving calculating unit 473 is not limited to the example of FIG. 15.

With respect to each pixel PX, the accumulated driving calculating unit 473 may calculate the accumulated driving value ADV of each pixel PX by summing the input image data IDST for the pixel PX during the plurality of frame periods, and taking the product of the input image data IDAT and weights for pixels disposed adjacent to the pixel PX during the plurality of frame periods. For example, as illustrated in FIG. 16, to calculate the accumulated driving value ADV of a first pixel PX1, the accumulated driving calculating unit 473 may calculate adjacent pixel accumulated driving values D2*W1, D3*W1, D4*W1, D5*W1, D6*W2, D7*W2, D8*W2 and D9*W2 by multiplying the input image data D2, D3, D4, D5, D6, D7, D8 and D9 for second through ninth pixels PX2, PX3, PX4, PX5, PX6, PX7, PX8 and PX9, respectively, which are disposed adjacent to the first pixel PX1 during the plurality of frame periods by weights W1 and W2 according to a distance from the first pixel PX1, and may sum the input image data DI for the first pixel PX1 during the plurality of frame periods and the adjacent pixel accumulated driving values D2*W1, D3*W1, D4*W1, D5*W1, D6*W2, D7*W2, D8*W2 and D9*W2. Although FIG. 16 illustrates an example in which the input image data D2 through D9 for eight pixels PX2 through PX9 which are disposed adjacent to the first pixel PX1 are considered to calculate the accumulated driving value ADV of the first pixel PX1, but the accumulated driving calculating unit 473 is not limited to the example of FIG. 16. For example, to calculate the accumulated driving value ADV for each pixel PX, the accumulated driving calculating unit 473 may consider the input image data IDAT for twenty four pixels PX which are disposed adjacent to the pixel PX, or it may consider the input image data IDAT for thirty five pixels PX which are disposed adjacent to the pixel PX.

In an embodiment, the compensation value determining unit 474 may determine the light emitting element efficiencies of the plurality of pixels PX based on the efficiency data EFFD and the input image data IDAT, and may determine color coordinate compensation values CCCV for the plurality of pixels PX based on the color coordinate compensation data CCCD′, the light emitting element efficiencies of the plurality of pixels PX and the accumulated driving values ADV of the plurality of pixels PX.

In an embodiment, the data correcting unit 476 may generate the corrected image data CDAT for the plurality of pixels PX by correcting the input image data IDAT for the plurality of pixels PX based on the color coordinate compensation values CCCV for the plurality of pixels PX.

In the display device 400, according to an embodiment, the color coordinate compensation values CCCV for the plurality of pixels PX may be determined based on the color coordinate compensation data CCCD′, the efficiency data EFFD and the accumulated driving values ADV of the plurality of pixels PX. Additionally, the corrected image data CDAT may be generated by correcting the input image data IDAT based on the color coordinate compensation values CCCV, and an image may be displayed based on the corrected image data CDAT. The image displayed based on the corrected image data CDAT may have a desired color coordinate, and thus, a color drift phenomenon may be prevented in the display device 400.

FIG. 18 is a block diagram illustrating an electronic device including a display device, according to an embodiment.

In an embodiment and referring to FIG. 18, an electronic device 1100 may include a processor 1110, a memory device 1120, a storage device 1130, an input/output (I/O) device 1140, a power supply 1150 and a display device 1160. The electronic device 1100 may further include a plurality of ports for communicating with a video card, a sound card, a memory card, a universal serial bus (USB) device, other electric devices, etc.

The processor 1110 may perform various computing functions or tasks and may be an application processor, a micro-processor, a central processing unit, etc. The processor 1110 may be coupled to other components via an address bus, a control bus, a data bus, etc. Further, in an embodiment, the processor 1110 may be further coupled to an extended bus such as a peripheral component interconnection (PCI) bus.

The memory device 1120 may store data for operations of the electronic device 1100. For example, the memory device 1120 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc., and/or at least one volatile memory device such as a dynamic random access memory (DRAM) device, a static random access memory (SRAM) device, a mobile dynamic random access memory (mobile DRAM) device, etc.

The storage device 1130 may be a solid state drive (SSD) device, a hard disk drive (HDD) device, a compact disc-read only memory (CD-ROM) device, etc. The I/O device 1140 may be an input device such as a keyboard, a keypad, a mouse, a touch screen, etc., and an output device such as a printer, a speaker, etc. The power supply 1150 may supply power for operations of the electronic device 1100. The display device 1160 may be coupled to other components through the buses or other communication links.

The display device 1160 may store color coordinate compensation data representing a color coordinate compensation value according to a temperature value and a light emitting element efficiency, may store efficiency data representing the light emitting element efficiency according to a gray level, may determine temperature values (or accumulated driving values) of a plurality of pixels, may determine color coordinate compensation values for the plurality of pixels based on the color coordinate compensation data, the efficiency data and the temperature values (or the accumulated driving values) of the plurality of pixels, and may correct image data based on the color coordinate compensation values. Accordingly, a color drift phenomenon may be prevented in the display device 1160.

The invention may be applied to any display device 1160, and any electronic device 1100 which includes the display device 1160. For example, the inventive concepts may be applied to a television (TV) (e.g., a digital TV, a 3D TV, etc.), a smart phone, a wearable electronic device, a tablet computer, a mobile phone, a personal computer (PC), a home appliance, a laptop computer, a personal digital assistant (PDA), a portable multimedia player (PMP), a digital camera, a music player, a portable game console, a navigation device, etc.

The foregoing is illustrative of embodiments of the invention and is not to be construed as limiting thereof. Although a few embodiments have been described, those skilled in the art will readily appreciate that many modifications are possible in the invention without materially departing from the novel teachings and advantages of the invention. Accordingly, all such modifications are intended to be included within the scope of the invention. Therefore, it is to be understood that the foregoing is illustrative of various embodiments and is not to be construed as limited to the specific embodiments disclosed, and that modifications to the disclosed embodiments, as well as other embodiments, are intended to be included within the scope of the invention. Moreover, the embodiments or parts of the embodiments may be combined in whole or in part without departing from the scope of the invention.

What is claimed is:

1. A display device comprising:
a display panel including a plurality of pixels; and
a panel driver coupled to the display panel, wherein the panel driver is configured to store color coordinate compensation data which represents a color coordinate compensation value according to a temperature value and a light emitting element efficiency, store efficiency data which represents the light emitting element efficiency according to a gray level, determine temperature values of the plurality of pixels, determine color coordinate compensation values for the plurality of pixels based on the color coordinate compensation data, the efficiency data and the temperature values of the plurality of pixels, generate corrected image data by correcting input image data based on the color coordinate compensation values, and drive the display panel based on the corrected image data.

2. The display device of claim 1, wherein the panel driver includes:
a color coordinate compensation lookup table configured to store the color coordinate compensation data; and
an efficiency lookup table configured to store the efficiency data,
wherein the panel driver determines the light emitting element efficiency which corresponds to a gray level indicated by the input image data for each of the plurality of pixels using the efficiency lookup table, and determines the color coordinate compensation value which corresponds to the temperature value and the light emitting element efficiency for each of the plurality of pixels using the color coordinate compensation lookup table.

3. The display device of claim 1, wherein, with respect to each of the plurality of pixels, the panel driver generates the corrected image data by adding the color coordinate compensation value to a color coordinate which corresponds to the input image data.

4. The display device of claim 1, wherein the panel driver includes:
a scan driver configured to provide scan signals to the plurality of pixels;
a data driver configured to provide data signals to the plurality of pixels based on the corrected image data;
a sensing circuit configured to generate sensing values by performing a sensing operation on the plurality of pixels;
a nonvolatile memory configured to store the color coordinate compensation data and the efficiency data; and
a controller configured to determine the color coordinate compensation values for the plurality of pixels based on the color coordinate compensation data, the efficiency data and the temperature values of the plurality of pixels, and to generate the corrected image data by correcting the input image data based on the color coordinate compensation values.

5. The display device of claim 4, wherein the sensing circuit generates the sensing values for pixels in at least one row among the plurality of pixels by performing the sensing operation on the pixels in the at least one row during a blank period of a frame period, and provides the sensing values for the pixels in the at least one row to the controller,
wherein the controller determines the temperature values of the pixels in the at least one row based on the sensing values for the pixels in the at least one row.

6. The display device of claim 5, wherein the at least one row on which the sensing operation is performed is randomly selected from a plurality of rows of the display panel during the blank period of each frame period.

7. The display device of claim 4, wherein each of the plurality of pixels includes a red subpixel, a green subpixel and a blue subpixel, and
wherein, to store the color coordinate compensation data, the nonvolatile memory includes:
a red color coordinate compensation lookup table configured to store red color coordinate compensation values for the red subpixel at a plurality of reference temperatures and a plurality of reference red light emitting element efficiencies;
a green color coordinate compensation lookup table configured to store green color coordinate compensation values for the green subpixel at the plurality of reference temperatures and a plurality of reference green light emitting element efficiencies; and
a blue color coordinate compensation lookup table configured to store blue color coordinate compensation values for the blue subpixel at the plurality of reference temperatures and a plurality of reference blue light emitting element efficiencies, and
wherein, to store the efficiency data, the nonvolatile memory further includes:
a red efficiency lookup table configured to store red light emitting element efficiencies for the red subpixel at a plurality of reference gray levels;
a green efficiency lookup table configured to store green light emitting element efficiencies for the green subpixel at the plurality of reference gray levels; and
a blue efficiency lookup table configured to store blue light emitting element efficiencies for the blue subpixel at the plurality of reference gray levels.

8. The display device of claim 7, wherein the controller includes:
a data loading unit in which the red color coordinate compensation lookup table, the green color coordinate compensation lookup table, the blue color coordinate compensation lookup table, the red efficiency lookup table, the green efficiency lookup table and the blue efficiency lookup table are uploaded from the nonvolatile memory, the sensing values are uploaded from the sensing circuit, and the input image data are uploaded;
a compensation value determining unit configured to determine the light emitting element efficiency of each of the red subpixel, green subpixel and blue subpixel which are using the input image data, the red efficiency lookup table, the green efficiency lookup table and the blue efficiency lookup table, to determine the temperature values of the red subpixel, green subpixel and blue subpixel based on the sensing values for the red subpixel, green subpixel and blue subpixel, and to determine the color coordinate compensation values for the red subpixel, green subpixel and blue subpixel using the light emitting element efficiency of each of the red subpixel, green subpixel and blue subpixel, the temperature values of the red subpixel, green subpixel and blue subpixel, the red color coordinate compensation lookup table, the green color coordinate compensation lookup table and the blue color coordinate compensation lookup table; and
a data correcting unit configured to generate corrected image data for the red subpixel, green subpixel and blue subpixel by correcting the input image data for the red subpixel, green subpixel and blue subpixel based on the color coordinate compensation values for the red subpixel, green subpixel, and blue subpixel.

9. The display device of claim 8, wherein the compensation value determining unit extracts the red light emitting element efficiencies at two reference gray levels which are disposed adjacent to a gray level indicated by the input image data for the red subpixel among the plurality of reference gray levels from the red efficiency lookup table, and determines the light emitting element efficiency of the red subpixel by interpolating the red light emitting element efficiencies at the two reference gray levels,
wherein the compensation value determining unit extracts the green light emitting element efficiencies at two reference gray levels which are disposed adjacent to a gray level indicated by the input image data for the green subpixel among the plurality of reference gray levels from the green efficiency lookup table, and determines the light emitting element efficiency of the green subpixel by interpolating the green light emitting element efficiencies at the two reference gray levels, and
wherein the compensation value determining unit extracts the blue light emitting element efficiencies at two reference gray levels which are disposed adjacent to a gray level indicated by the input image data for the blue subpixel among the plurality of reference gray levels from the blue efficiency lookup table, and determines the light emitting element efficiency of the blue subpixel by interpolating the blue light emitting element efficiencies at the two reference gray levels.

10. The display device of claim 8, wherein the compensation value determining unit extracts the red color coordinate compensation values at two reference temperatures which are disposed adjacent to the temperature value of the red subpixel among the plurality of reference temperatures and at two reference red light emitting element efficiencies which are disposed adjacent to the light emitting element efficiency of the red subpixel among the plurality of reference red light emitting element efficiencies from the red color coordinate compensation lookup table, and determines the color coordinate compensation value for the red subpixel by interpolating the red color coordinate compensation values at the two reference temperatures and at the two reference red light emitting element efficiencies,
wherein the compensation value determining unit extracts the green color coordinate compensation values at two reference temperatures which are disposed adjacent to the temperature value of the green subpixel among the plurality of reference temperatures and at two reference green light emitting element efficiencies which are disposed adjacent to the light emitting element efficiency of the green subpixel among the plurality of reference green light emitting element efficiencies from the green color coordinate compensation lookup table, and determines the color coordinate compensation value for the green subpixel by interpolating the green color coordinate compensation values at the two reference temperatures and at the two reference green light emitting element efficiencies, and
wherein the compensation value determining unit extracts the blue color coordinate compensation values at two reference temperatures which are disposed adjacent to the temperature value of the blue subpixel among the plurality of reference temperatures and at two reference blue light emitting element efficiencies which are disposed adjacent to the light emitting element efficiency of the blue subpixel among the plurality of reference blue light emitting element efficiencies from the blue color coordinate compensation lookup table, and determines the color coordinate compensation value for the blue subpixel by interpolating the blue color coordinate compensation values at the two reference temperatures and at the two reference blue light emitting element efficiencies.

11. The display device of claim 8, wherein the data correcting unit includes:
a first color space converting unit configured to convert the input image data in a first color space into color coordinate data and luminance data in a second color space;
a compensation value applying unit configured to calculate a compensation sum vector by summing a first vector which corresponds to the color coordinate compensation value for the red subpixel, a second vector which corresponds to the color coordinate compensation value for the green subpixel and a third vector which corresponds to the color coordinate compensation value for the blue subpixel, and to calculate compensated color coordinate data by applying the compensation sum vector to the color coordinate data in the second color space; and
a second color space converting unit configured to convert the compensated color coordinate data and the luminance data in the second color space into the corrected image data in the first color space.

12. The display device of claim 1, further comprising:
a plurality of temperature sensors arranged at a plurality of reference positions of the display panel.

13. The display device of claim 12, wherein the panel driver receives reference temperature values at the plurality of reference positions from the plurality of temperature sensors, and
wherein, with respect to each of the plurality of pixels, the panel driver determines the temperature value of each of the plurality of pixels by interpolating the reference temperature values at four reference positions disposed adjacent to each of the plurality of pixels among the plurality of reference positions.

14. A display device comprising:
a display panel including a plurality of pixels; and
a panel driver coupled to the display panel, wherein the panel driver is configured to store color coordinate compensation data which represents a color coordinate compensation value according to an accumulated driving value and a light emitting element efficiency, to store efficiency data which represents the light emitting element efficiency according to a gray level, to determine accumulated driving values of the plurality of pixels based on input image data, to determine color coordinate compensation values for the plurality of pixels based on the color coordinate compensation data, the efficiency data and the accumulated driving values of the plurality of pixels, to generate corrected image data by correcting input image data based on the color coordinate compensation values, and to drive the display panel based on the corrected image data.

15. The display device of claim 14, wherein the panel driver includes:
a scan driver configured to provide scan signals to the plurality of pixels;
a data driver configured to provide data signals to the plurality of pixels based on the corrected image data;
a nonvolatile memory configured to store the color coordinate compensation data and the efficiency data; and
a controller configured to determine the color coordinate compensation values for the plurality of pixels based on the color coordinate compensation data, the efficiency data and the accumulated driving values of the plurality of pixels, and to generate the corrected image data by correcting the input image data based on the color coordinate compensation values.

16. The display device of claim 15, wherein the controller includes:
a data loading unit in which the color coordinate compensation data and the efficiency data are uploaded from the nonvolatile memory, and the input image data are uploaded;
an accumulated driving calculating unit configured to calculate the accumulated driving values of the plurality of pixels by accumulating the input image data for a plurality of frame periods;
a compensation value determining unit configured to determine the light emitting element efficiencies of the plurality of pixels based on the efficiency data and the input image data, and to determine the color coordinate compensation values for the plurality of pixels based on the color coordinate compensation data, the light emitting element efficiencies of the plurality of pixels and the accumulated driving values of the plurality of pixels; and
a data correcting unit configured to generate the corrected image data for the plurality of pixels by correcting the input image data for the plurality of pixels based on the color coordinate compensation values for the plurality of pixels.

17. The display device of claim 16, wherein, with respect to each of the plurality of pixels, the accumulated driving calculating unit calculates the accumulated driving value of each of the plurality of pixels by summing the input image data for each of the plurality of pixels for the plurality of frame periods, and calculating the products of the input image data and weights for pixels which are disposed adjacent to each of the plurality of pixels for the plurality of frame periods.

18. A method of operating a display device, the method comprising:
storing color coordinate compensation data which represents a color coordinate compensation value according to a temperature value and a light emitting element efficiency;
storing efficiency data which represents the light emitting element efficiency according to a gray level;
determining temperature values of a plurality of pixels of the display device;
determining color coordinate compensation values for the plurality of pixels based on the color coordinate compensation data, the efficiency data and the temperature values of the plurality of pixels;
generating corrected image data by correcting input image data based on the color coordinate compensation values; and
driving a display panel based on the corrected image data.

19. The method of claim 18, wherein determining the temperature values of the plurality of pixels includes:
generating sensing values for pixels in at least one row among the plurality of pixels by performing a sensing operation on the pixels in the at least one row during a blank period of a frame period; and
determining the temperature values of the pixels in the at least one row based on the sensing values for the pixels in the at least one row.

20. The method of claim 18, wherein determining the color coordinate compensation values for the plurality of pixels includes:
determining light emitting element efficiencies of the plurality of pixels based on the efficiency data and the input image data; and
determining the color coordinate compensation values for the plurality of pixels based on the color coordinate compensation data, the light emitting element efficiencies of the plurality of pixels and the temperature values of the plurality of pixels.
